(19) United States
(12) Patent Application Publication
(10) Pub. No.: US 2014/0101252 A1
(43) Pub. Date: Apr. 10, 2014

(54) Mobile Message Sharing through Employment of Social Media Platform

(71) Applicant: Cezary Kolodziej, Deer Park, IL (US)

(72) Inventor: Cezary Kolodziej, Deer Park, IL (US)

(21) Appl. No.: 14/046,594

(22) Filed: Oct. 4, 2013

Related U.S. Application Data
(60) Provisional application No. 61/710,701, filed on Oct. 6, 2012.

(51) Int. Cl. H04L 12/58

(52) U.S. Cl. CPC H04L 51/32
USPC 709/204

(57) ABSTRACT

A mobile messaging server of an apparatus in an example interacts with a social media platform to cause the social media platform to share, with a social network of friends of a user, a mobile message that is received by the user and comprises one or more of images, bar codes, videos, and/or simple plain text.

### DESCRIPTION OF THE DRAWINGS

Features of exemplary implementations of the invention will become apparent from the description, the claims, and the accompanying drawings in which:

FIG. 1 is a representation of an implementation of an apparatus that comprises a wireless communication data network, a mobile messaging server that is in charge of sending rich content within a mobile message to a mobile device. The rich content of the message can be shared by user with network of friends via social media platform.

FIG. 2 is a representation of the mobile device of an implementation of the apparatus of FIG. 1 with display capable of rendering different types of rich content such as images, videos and plain.

FIG. 3 is a representation of an implementation of the mobile device of FIG. 2 and illustrates how a rich media content of mobile message can be rendered on the display of the mobile device.

FIG. 4 is a representation of an implementation of the mobile device of FIG. 2 and illustrates how messaging server provides opportunities to the user to select on which social media portal the rich media content of the mobile message will be posted.

FIG. 5 is a representation of a portal of social media platform of an implementation of the apparatus of FIG. 1 where user can share mobile message with network of friends on selected social media platform

### DETAILED DESCRIPTION

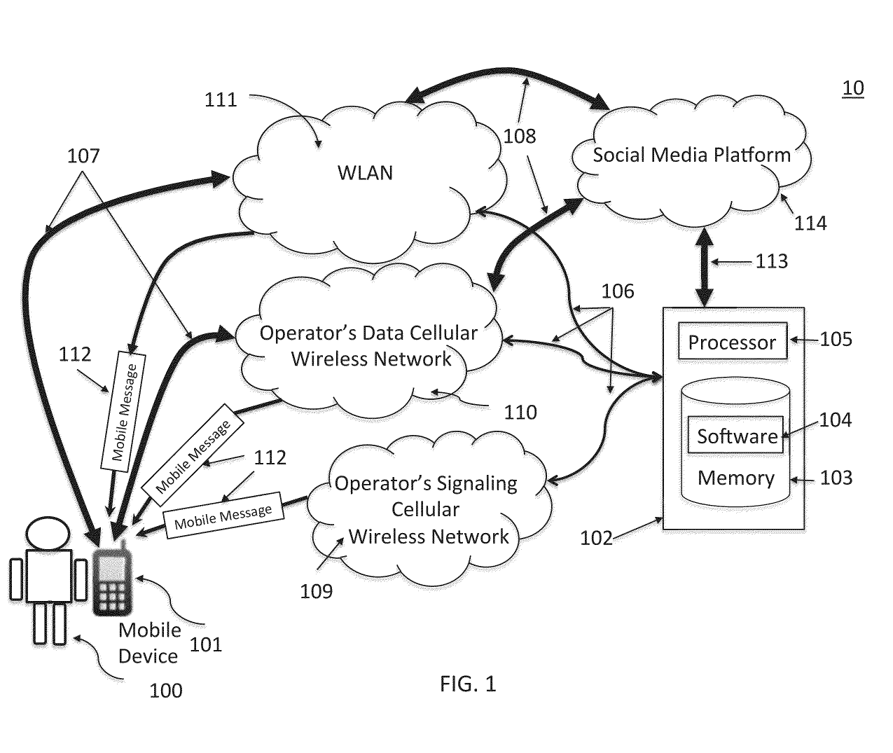

Turning to FIG. 1, an implementation of an apparatus (10) comprises a user (100) that receives a mobile message (112) on mobile device (101) from the mobile messaging server (102).

Referring to FIG. 1, the user (100) in an example comprises one or more of a human, a woman, a man, an adult, a child, a customer, a player, a trainee, an intern, a student, a graduate, an elderly person, and/or a professional.

Referring to FIG. 1, mobile messaging communication in an example comprises delivery and/or receipt of one or more mobile messages (112). Mobile messaging communication in an example comprises one or more of Short Message Service (SMS), Multimedia Messaging Service (MMS), Wireless Application Protocol-Push (WAP-Push) and/or in-application software (in-app) notification pushed/delivered to the mobile device (100) via a signaling cellular network (109), a data cellular network (110), and/or the local wireless communication data network (111).

Referring to FIG. 1, the user (100) may be a customer of the signaling cellular network (109), the data cellular network (110), and/or the local wireless communication data network (111). The user (100) as the customer in an example employs the mobile device (101) for mobile communication and/or mobile messaging communication.

Referring to FIG. 1, the mobile device (101) in an example comprises one or more of a mobile device, mobile phone, electronic tablet, wireless modem, personal digital assistant (pda), laptop, smartphone, and/or computing device.

Referring to FIG. 1, the mobile message (112) might in an example comprise rich content that comprises one or more of images, bar codes, videos and simple plain text with one or more unique clickable action links for sharing the original content on social media platform (114).

Referring to FIG. 1, the messaging server (102) in an example delivers the mobile message (112) to the mobile device (101).

The clickable action for sharing the original content of the mobile message (112) with social media platform (114) is triggered by user (100) by clicking on the on the display of the mobile device (101) on the clickable action link. The mobile device (101) communicates via wireless communication links (107) with either a data cellular network (110), and/or the local wireless communication data network (111) and further via Internet communication links (106) with the messaging server (102).

After the clickable action for sharing of the original content of the mobile message (112) reaches the messaging server (102), it is handled by mobile messaging's software (103) stored in its memory (103) and executed by its processor (105).

The messaging server (102) redirects the sharing request of the user (100) to the social media platform (114) via Internet communication links (113) and then the social media platform (114) presents sharing options to the user (100) via Internet communication links (108) through either a data cellular network (110), and/or the local wireless communication data network (111) and further via wireless communication links (107).

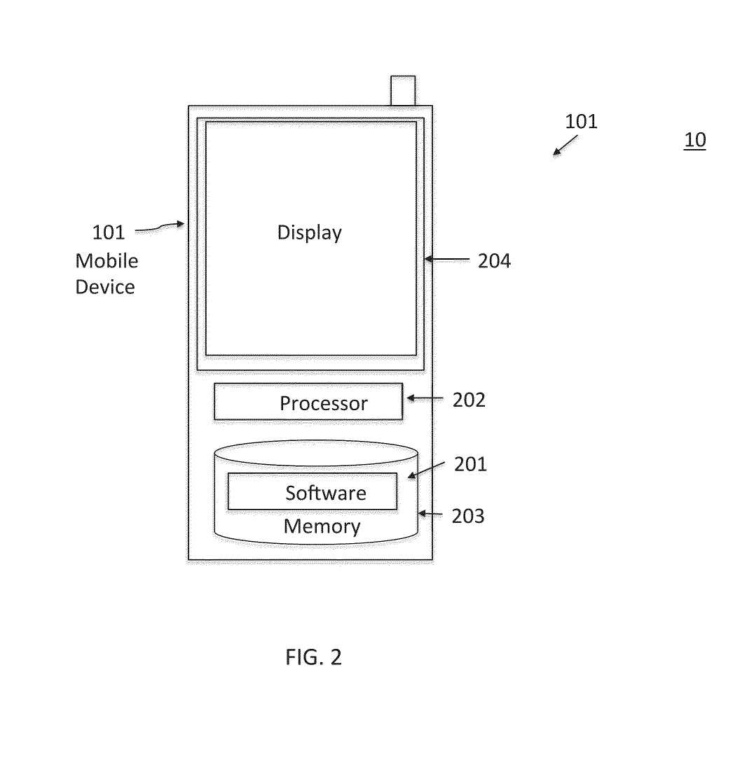

Referring to FIG. 2, the mobile device (101) in an example comprises software (201) stored in its memory (203) and executed by its processor (202). The mobile device (100) renders the rich content received in the mobile message (112 in FIG. 1) on its display (204).

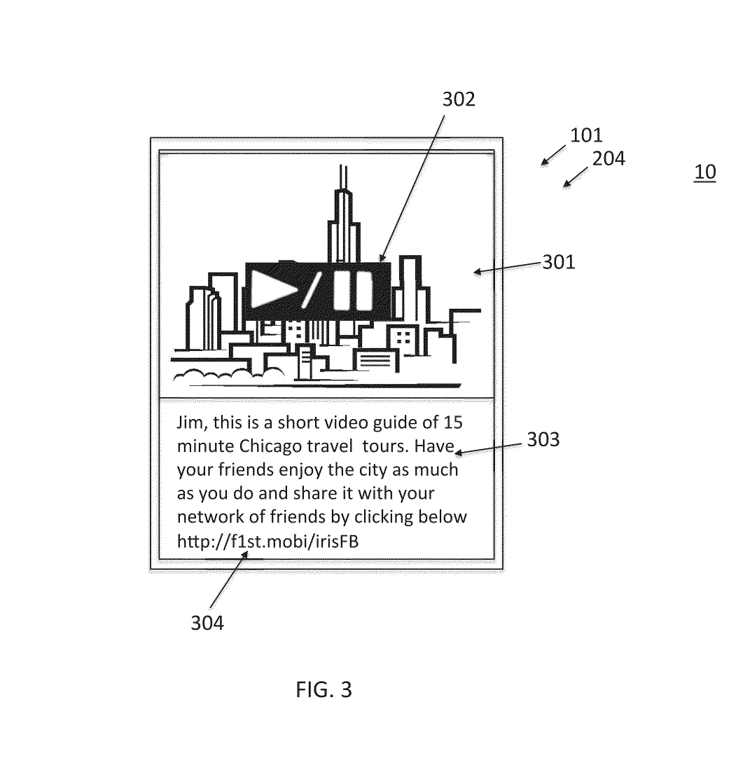

FIGS. 1-3 present an example of a display (204) of the mobile device (101) with a rendered rich content of the mobile message (112). The mobile message (112) in an example comprises a video file (301) and a plain text file (303). The video file (301) can be played by clicking on a “play” icon (302). The plain text file (303) in an example comprises a clickable action link (304).

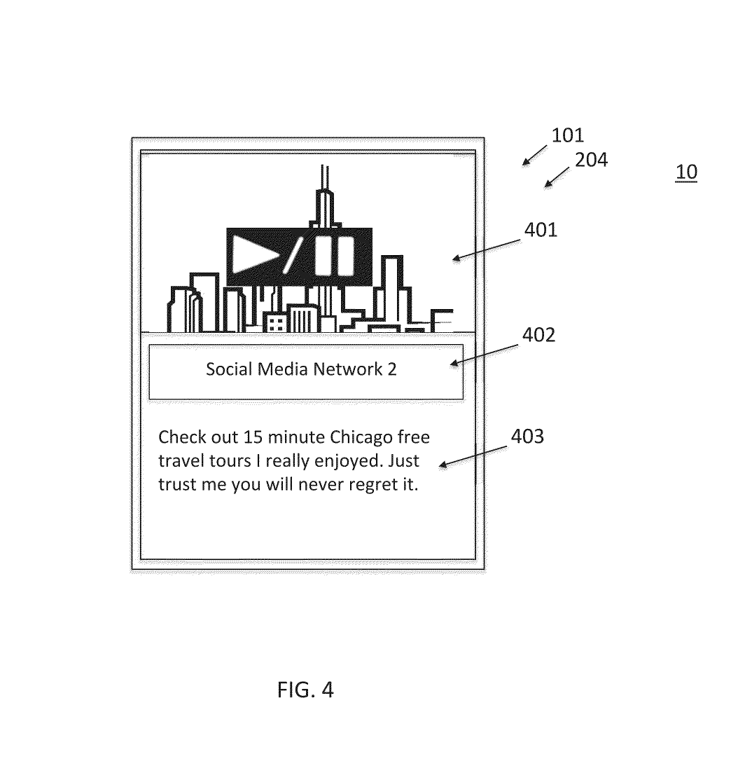

FIGS. 1-4 present an example of a display (204) of the mobile device (101) after the user (101) clicks on the clickable action link (304). FIG. 4 presents an example comprises a thumbnail (401) of the mobile message (112), one or more clickable icons of social media network (402) and an additional text (403) to be shared along with the mobile message (112) via the social medial platform (114).

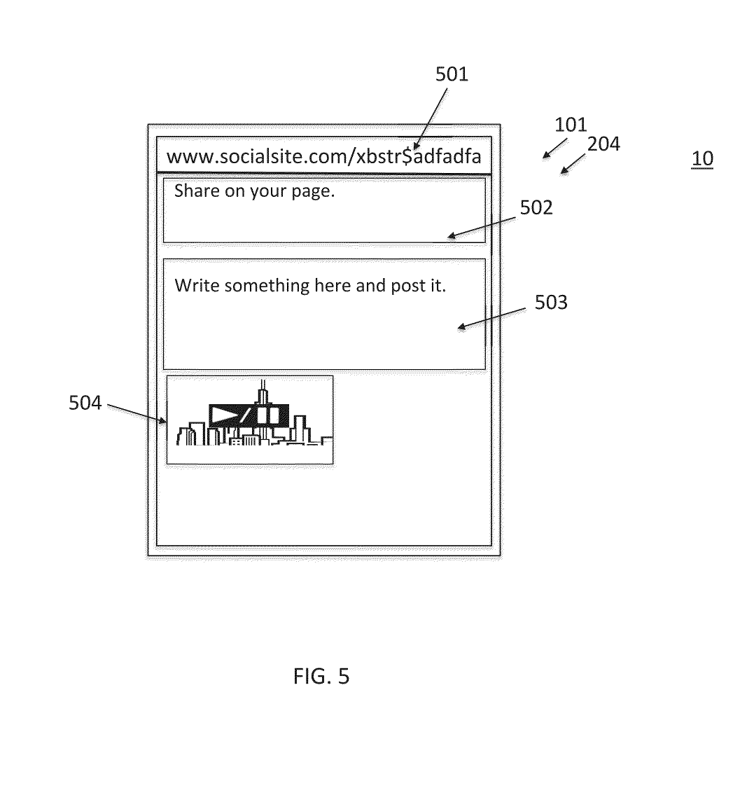

FIGS. 1-5 present an example of a display (204) of the mobile device (101) after the user (101) clicks on the clickable icon of social media network (402). FIG. 5 presents an example comprises a Universal Resource Locator (URL) (501) of the social media platform (114), clickable sharing action (502), an additional writable panel (503) for additional text to be shared along with the rich content of the mobile message (112), and a thumbnail (504) of the original mobile message (112). After the clickable sharing action (502) is clicked by the user (100), the message (112) together with the content of an additional writable panel (503) is viewable network of friends of user (100) via social media platform (114).

An exemplary approach interacts with a social media platform (114), through employment of a messaging server (102), to cause the social media platform (114) to share, with a social network of friends of a user (100), a mobile message (112) that is received by the user (100) and comprises one or more of images, bar codes, videos, and/or simple plain text.

An exemplary implementation comprises a messaging server (102) that interacts with a social media platform (114) to cause the social media platform (114) to share, with a social network of friends of a user (100), a mobile message (112) that is received by the user (100) and comprises one or more of images, bar codes, videos, and/or simple plain text.

An implementation of the apparatus (10) comprises an algorithm, procedure, program, process, mechanism, engine, model, coordinator, module, unit, application, software, code, and/or logic. An implementation of the apparatus (10) comprises one or more user-level programs, for example, user interface logic residing in one or more user-level program files.

An implementation of the apparatus (10) comprises a plurality of components such as one or more of electronic components, chemical components, organic components, mechanical components, hardware components, optical components, and/or computer software components. A number of such components may be combined or divided in an implementation of the apparatus (10). One or more components of an implementation of the apparatus (10) and/or one or more parts thereof may comprise one or more of a computing, communication, interactive, and/or imaging device, interface, computer, and/or machine. One or more components of an implementation of the apparatus (10) and/or one or more parts thereof may serve to allow selection, employment, channeling, processing, analysis, communication, and/or transformation of electrical signals and/or between and/or among physical, logical, transitional, transitory, persistent, and/or electrical signals, inputs, outputs, measurements, and/or representations.

A plurality of instances of a particular component may be present in an implementation of the apparatus (10). One or more features described herein in connection with one or more components and/or one or more parts thereof may be applicable and/or extendible analogously to one or more other instances of the particular component and/or other components in an implementation of the apparatus (10). One or more features described herein in connection with one or more components and/or one or more parts thereof may be omitted from or modified in one or more other instances of the particular component and/or other components in an implementation of the apparatus (10). An exemplary technical effect is one or more exemplary and/or desirable functions, approaches, and/or procedures. An exemplary component of an implementation of the apparatus (10) may employ and/or comprise a set and/or series of computer instructions written in or implemented with any of a number of programming languages, as will be appreciated by those skilled in the art.

An implementation of the apparatus (10) may comprise any (e.g., horizontal, oblique, angled, or vertical) orientation, with the description and figures herein illustrating an exemplary orientation of an exemplary implementation of the apparatus (10), for explanatory purposes. One or more components of an implementation of the apparatus (10) and/or one or more parts thereof may occupy a number of locations of the apparatus (10).

An implementation of the apparatus (10) may encompass an article and/or an article of manufacture. The article may comprise one or more computer-readable signal-bearing media. The article may comprise means and/or instructions in the one or more media for one or more exemplary and/or desirable functions, approaches, and/or procedures.

An implementation of the apparatus (10) may employ one or more computer readable signal-bearing media. A computer-readable signal-bearing medium may store software, firmware and/or assembly language for performing one or more portions of an implementation of the apparatus (10). An example of a computer-readable signal bearing medium for an implementation of the apparatus (10) may comprise a memory and/or recordable data storage medium of the mobile device (101), the memory (103), the signaling cellular network (109), the data cellular network (110), and/or the local wireless communication data network (111). A computer-readable signal-bearing medium for an implementation of the apparatus (10) in an example may comprise a device and/or non-transitory recording medium into which data can be located for a length of time and subsequently retrieved. Data in an example may be one or more of located, placed, moved, and/or copied into a non-transitory recording medium as a computer-readable signal bearing medium for an implementation of the apparatus (10). Data in an example may be one or more of located, stored, saved, and/or held until a later time in a non-transitory recording medium as a computer-readable signal bearing medium for an implementation of the apparatus (10). Data in an example may be one or more of retrieved, accessed, obtained, restored, and/or reproduced from a non-transitory recording medium as a computer-readable signal bearing medium for an implementation of the apparatus (10). For example, one or more portions and/or the entirety of the original data can be retrieved from a non-transitory recording medium of an implementation of the apparatus (10). A computer-readable signal-bearing medium for an implementation of the apparatus (10) in an example may comprise one or more of a magnetic, electrical, optical, biological, chemical, and/or atomic data storage medium. For example, an implementation of the computer-readable signal-bearing medium may comprise one or more flash drives, optical discs, memory cards, computer networks, CDs (compact discs), DVDs (digital video discs), hard drives, portable drives, and/or electronic memory. A computer-readable signal-bearing medium in an example may comprise a physical computer medium, computer-readable signal-bearing tangible medium, and/or non-transitory medium.

The steps or operations described herein are examples. There may be variations to these steps or operations without departing from the spirit of the invention. For example, the steps may be performed in a differing order, or steps may be added, deleted, or modified.

Although exemplary implementation of the invention has been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a messaging server that interacts with a social media platform to cause the social media platform to share, with a social network of friends of a user, a mobile message that is received by the user and comprises one or more of images, bar codes, videos, and/or simple plain text.

2. The apparatus of claim 1, wherein the mobile message allows one or more clickable actions by the user to cause the messaging server to cause the social media platform to share, with the social network of friends of the user, one or more of the one or more of images, bar codes, videos, and/or simple plain text from the message.

3. The apparatus of claim 2, wherein a plurality of social networks of friends of the user comprises the social network of friends of the user, wherein the mobile message is shareable, through employment of one or more of the one or more clickable actions by the user, with any one or more of the plurality of social networks of friends of the user.

4. The apparatus of claim 2, wherein content of the message comprises the one or more of images, bar codes, videos, and/or simple plain text, wherein the message is shared by the user through performance of one or more of the one or more clickable actions, wherein the message comprises of one or more writable panels that allow the user to cause additional text to be shared, with the social network of friends of the user, along with the content of the mobile message.

5. The apparatus of claim 1, wherein a plurality of social networks of friends of the user comprises the social network of friends of the user, wherein the mobile message is shareable by the user with any one or more of the plurality of social networks of friends of the user.

6. The apparatus of claim 1, wherein a plurality of social media platforms comprise the social media platform, wherein the mobile message allows one or more clickable actions by the user to cause the messaging server to cause the social media platform to share, with any one or more of the plurality of social media platforms, one or more of the one or more of images, bar codes, videos, and/or simple plain text from the message.

7. The apparatus of claim 6, wherein a clickable action of the one or more clickable actions for sharing the mobile message with the any one or more of the plurality of social media platforms is detected and recorded by the messaging server.

8. A method, comprising the step of:
interacting with a social media platform, through employment of a messaging server, to cause the social media platform to share, with a social network of friends of a user, a mobile message that is received by the user and comprises one or more of images, bar codes, videos, and/or simple plain text.
